(19) United States
(12) Patent Application Publication
(10) Pub. No.: US 2026/0288054 A1
(43) Pub. Date: Sep. 24, 2026

(54) IMAGE FORMING APPARATUS INCLUDING PROTRUSIONS ON MAIN HOUSING FOR RESTRICTING POSTURE DEVIATION OF FIXING DEVICE DURING ATTACHMENT OF THE FIXING DEVICE TO THE MAIN HOUSING

(71) Applicant: BROTHER KOGYO KABUSHIKI KAISHA, Nagoya (JP)

(72) Inventor: Kotaro TAKIFUJI, Nagoya (JP)

(73) Assignee: BROTHER KOGYO KABUSHIKI KAISHA, Nagoya (JP)

(21) Appl. No.: 19/563,461

(22) Filed: Mar. 11, 2026

(30) Foreign Application Priority Data
Mar. 21, 2025 (JP) 2025-046257

(51) Int. Cl. G03G 21/16; G03G 15/20

(52) U.S. Cl. CPC G03G 21/1647; G03G 15/2064; G03G 21/1619; G03G 2221/1639; G03G 2221/1654

(57) ABSTRACT

An image forming apparatus includes a main housing, and a fixing device attachable to the main housing in a first direction. The main housing includes first and second side walls opposing each other in a second direction crossing the first direction. The first side wall includes a protrusion protruding toward the second side wall. The protrusion is configured to contact a side surface of the fixing device during attachment of the fixing device to the main housing. When viewed in the second direction, the protrusion overlaps the side surface during the attachment of the fixing device to the main housing and does not overlap the side surface in a state where the fixing device is attached to the main housing.

### REFERENCE TO RELATED APPLICATIONS

This application claims priority from Japanese Patent Application No. 2025-046257 filed on Mar. 21, 2025. The entire content of the priority application is incorporated herein by reference.

### BACKGROUND ART

A printer includes a fixing device attachable to and detachable from a main housing of the printer. The fixing device includes a positioning pin. The positioning pin protrudes in a longitudinal direction of the fixing device. The main housing has a groove configured to engage the positioning pin.

### SUMMARY

In the above-described structure, the fixing device may not be attached to a correct location in the main housing in a case where either longitudinal end of the fixing device skews forward in an attachment direction relative to the other longitudinal end during the attachment of the fixing device to the main housing.

In view of the foregoing, it is an object of the present disclosure to provide an image forming apparatus in which a fixing device can be guided to a correct location in a main housing during the attachment of the fixing device to the main housing.

In order to attain the above and other object, the present disclosure provides image forming apparatus including a main housing and a fixing device. The fixing device includes a heating rotator and a pressure rotator. The fixing device is configured to be attached to the main housing from one side toward an other side in a first direction. The main housing includes a first side wall and a second side wall opposing the first side wall in a second direction crossing the first direction. The first side wall includes a protrusion protruding toward the second side wall. The fixing device has a side surface configured to face the first side wall. During attachment of the fixing device to the main housing, the protrusion restricts a posture of the fixing device by contacting the side surface of the fixing device; and the protrusion overlaps the side surface when viewed in the second direction. In a state where the fixing device is attached to the main housing, the protrusion does not overlap the side surface when viewed in the second direction.

With the above structure, since the protrusion is designed to overlap the side surface of the fixing device when viewed in the second direction during the attachment of the fixing device to the main housing, the protrusion can regulate the posture of the fixing device so that the fixing device can be guided into a correct location in the main housing. Further, since the protrusion is designed not to overlap the side surface of the fixing device when viewed in the second direction when the attachment of the fixing device to the main housing is complete, the protrusion does not interrupt positioning of the fixing device to the main housing.

### BRIEF DESCRIPTION OF DRAWINGS

FIG. 1 is a cross-sectional view of an image forming apparatus according to one embodiment.

FIG. 2 is a perspective view of a fixing device and a main housing.

FIG. 3 is a perspective view of the fixing device when viewed from the other side in a second direction.

FIG. 4A is a view illustrating a guide surface, a first recess, a second recess and a spring of the main housing and the fixing device.

FIG. 4B is an enlarged view of a region in the vicinity of a first boss of the fixing device.

FIG. 5 is a view illustrating bosses of the fixing device, metal plates of the main housing, and the springs.

FIG. 6A is a view illustrating a state where the first boss is guided by a first guide surface.

FIG. 6B is a view illustrating a state where the first boss is on a second guide surface.

FIG. 7A is a view illustrating a state where the first boss is off the guide surface.

FIG. 7B is a view illustrating a state where the first boss is received in the first recess.

FIG. 8 is an enlarged view of a region in the vicinity of protrusions of the main housing.

FIG. 9A is a cross-sectional view illustrating the spring, a first restricting part, and a second restricting part of the main housing in a state where the fixing device is not attached to the main housing.

FIG. 9B is a cross-sectional view illustrating the spring, the first restricting part, and the second restricting part of the main housing in a state where the fixing device is attached to the main housing.

FIG. 10 is a cross-sectional view of the main housing taken along a plane orthogonal to a third direction in the state where the fixing device is attached to the main housing.

FIG. 11A is a view illustrating the relationship between the protrusions and a side surface of the fixing device in a state where the first boss is on the first guide surface.

FIG. 11B is a view illustrating the relationship between the protrusions and the side surface of the fixing device in a state where the first boss is on the second guide surface.

FIG. 12A is a view illustrating the relationship between the protrusions and the side surface of the fixing device in a state immediately before the first boss is received in the first recess.

FIG. 12B is a view illustrating the relationship between the protrusions and the side surface of the fixing device in a state where the first boss is received in the first recess.

### DESCRIPTION

Hereinafter, one embodiment of the present disclosure will be described while referring to the accompanying drawings.

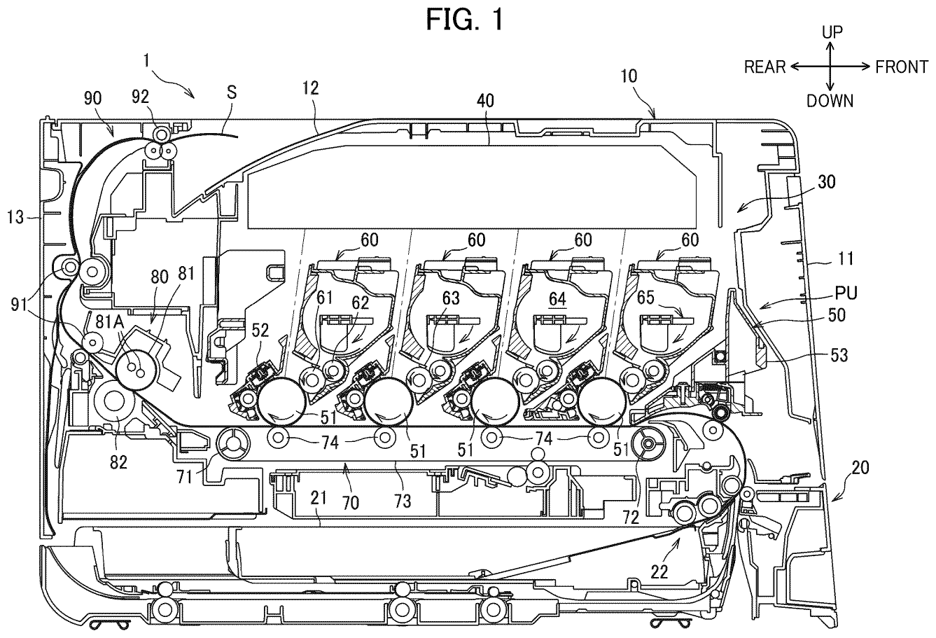

As illustrated in FIG. 1, an image forming apparatus 1 includes a main housing 10, a sheet feeding unit 20, an image forming unit 30, and a sheet discharging unit 90.

The main housing 10 includes a front cover 11, a discharge tray 12, and a rear cover 13. The front cover 11 is configured to open and close a front opening of the main housing 10. The rear cover 13 is configured to open and close a rear opening of the main housing 10.

The sheet feeding unit 20 includes a sheet tray 21, and a sheet feeding structure 22. The sheet tray 21 is configured to accommodate sheets S such as paper. The sheet feeding structure 22 is configured to feed the sheets S in the sheet tray 21 toward the image forming unit 30.

The image forming unit 30 includes an exposing device 40, a process unit PU, a transferring device 70, and a fixing device 80.

The exposing device 40 is positioned above the process unit PU. The exposing device 40 is configured to emit light beams to expose peripheral surfaces of photosensitive drums 51 to light.

The process unit PU is positioned between the sheet tray 21 and the exposing device 40. The process unit PU is configured to be attached to and detached from the main housing 10 through the front opening of the main housing 10 when the front cover 11 is opened. The process unit PU includes a drum cartridge 50 and toner cartridges 60.

The drum cartridge 50 includes the photosensitive drums 51, chargers 52 corresponding to the respective photosensitive drums 51, and a drum frame 53.

The drum frame 53 supports the photosensitive drums 51 and the chargers 52. The drum frame 53 is supported by the main housing 10 such that the drum frame 53 is movable relative to the main housing 10. The toner cartridges 60 can be detached to and attached to the drum frame 53.

The toner cartridges 60 respectively store toner of different colors. Each toner cartridge 60 includes a developing roller 61, a supply roller 62, a thickness regulating blade 63, a toner container 64 for storing toner, and an agitator 65.

The agitator 65 is configured to agitate the toner stored in the toner container 64. The agitator 65 is configured to supply the toner to the supply roller 62. The supply roller 62 is configured to supply the toner to the developing roller 61. The thickness regulating blade 63 is configured to regulate the toner on the developing roller 61 into a uniform thickness.

The transferring device 70 is positioned between the sheet tray 21 and the process unit PU. The transferring device 70 includes a drive roller 71, a follow roller 72, a conveying belt 73, and transfer rollers 74.

The conveying belt 73 is an endless belt for conveying the sheets S. The drive roller 71 and the follow roller 72 are configured to drive the conveying belt 73 to circularly move the same. The transfer rollers 74 are positioned in an inner space defined by an inner peripheral surface of the conveying belt 73. Each transfer roller 74 nips the conveying belt 73 in cooperation with the corresponding photosensitive drum 51.

The fixing device 80 includes a heating roller 81, and a pressure roller 82. The heating roller 81 is configured to heat each sheet S. Two heaters 81A are disposed inside the heating roller 81. The heating roller 81 is configured to rotate in response to receiving a driving force from a non-illustrated drive source. The heating roller 81 is an example of ‘heating rotator’ of the disclosure. The pressure roller 82 is an example of ‘pressure rotator’ of the disclosure.

The pressure roller 82 nips each sheet S in cooperation with the heating roller 81. The pressure roller 82 is configured to rotate following the rotation of the heating roller 81.

The chargers 52 are configured to charge the peripheral surfaces of the corresponding photosensitive drums 51. The exposing device 40 is configured to expose the peripheral surfaces of the respective photosensitive drums 51 to light, thereby forming an electrostatic latent image on the peripheral surface of each photosensitive drum 51. The developing roller 61 is configured to supply toner to the corresponding photosensitive drum 51, forming a toner image on the photosensitive drum 51.

The sheet feeding unit 20 is configured to convey each sheet S to a position between each photosensitive drum 51 and its corresponding transfer roller 74. The toner image on each photosensitive drum 51 is thus transferred onto the sheet S. After the toner image is transferred to the sheet S, the sheet S is conveyed to a position between the heating roller 81 and the pressure roller 82. In the fixing device 80, the toner image is thermally fixed to the sheet S.

The sheet discharging unit 90 includes conveying rollers 91 and discharge rollers 92. The conveying rollers 91 are configured to convey the sheets S to the discharge rollers 92, and the discharge rollers 92 are configured to discharge the sheets S onto the discharge tray 12.

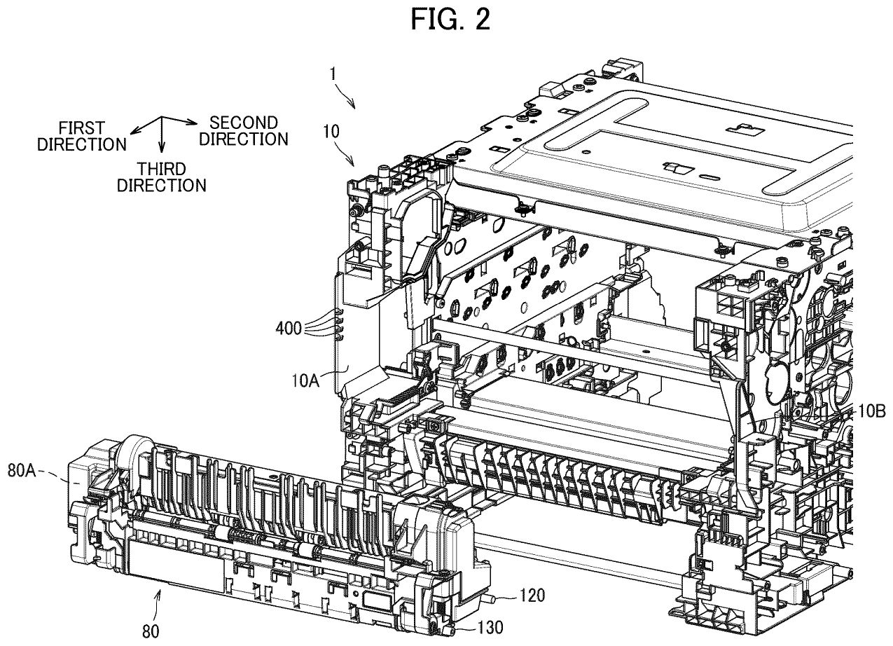

As illustrated in FIG. 2, the fixing device 80 is configured to be attached to and detached from the main housing 10. Specifically, the fixing device 80 can be attached to and detached from the main housing 10 through the rear opening of the main housing 10 when the rear cover 13 is opened. In the following description, directions will be referred to using the first direction, the second direction, and the third direction depicted in FIG. 2.

The first direction is a direction in which the fixing device 80 can be attached to and detached from the main housing 10. In the present embodiment, the first direction is parallel to a front-rear direction of the image forming apparatus 1. One side in the first direction corresponds to the rear side of the image forming apparatus 1, while the other side in the first direction corresponds to the front side of the image forming apparatus 1. The fixing device 80 is thus configured to be attached to the main housing 10 from the one side toward the other side in the first direction. The one side in the first direction is an upstream side in an attachment direction of the fixing device 80, while the other side in the first direction is a downstream side in the attachment direction of the fixing device 80.

The second direction crosses the first direction. In the present embodiment, the second direction is orthogonal to the first direction. The second direction is parallel to a left-right direction of the image forming apparatus 1. The second direction is parallel to a rotational axis of the heating roller 81. One side in the second direction corresponds to the left side of the image forming apparatus 1, while the other side in the second direction corresponds to the right side of the image forming apparatus 1. The second direction also corresponds to a longitudinal direction of the fixing device 80.

The third direction crosses both the first direction and the second direction. In the present embodiment, the second direction is orthogonal to both the first direction and the second direction. The third direction corresponds to an up-down direction of the image forming apparatus 1. One side in the third direction corresponds to the bottom side of the image forming apparatus 1, while the other side in the second direction corresponds to the upper side of the main housing 10.

Each arrow in the attached drawings will denotes the one side in the corresponding direction.

The main housing 10 includes a first side wall 10A and a second side wall 10B. The second side wall 10B is apart from the first side wall 10A in the second direction. The second side wall 10B is positioned on the one side in the second direction relative to the first side wall 10A. The fixing device 80 is configured to move along a path between the first side wall 10A and the second side wall 10B in a process of the fixing device 80 being attached to the main housing 10.

The first side wall 10A includes protrusions 400. Each protrusion 400 protrudes toward the second side wall 10B. The protrusions 400 are arranged at intervals in the third direction.

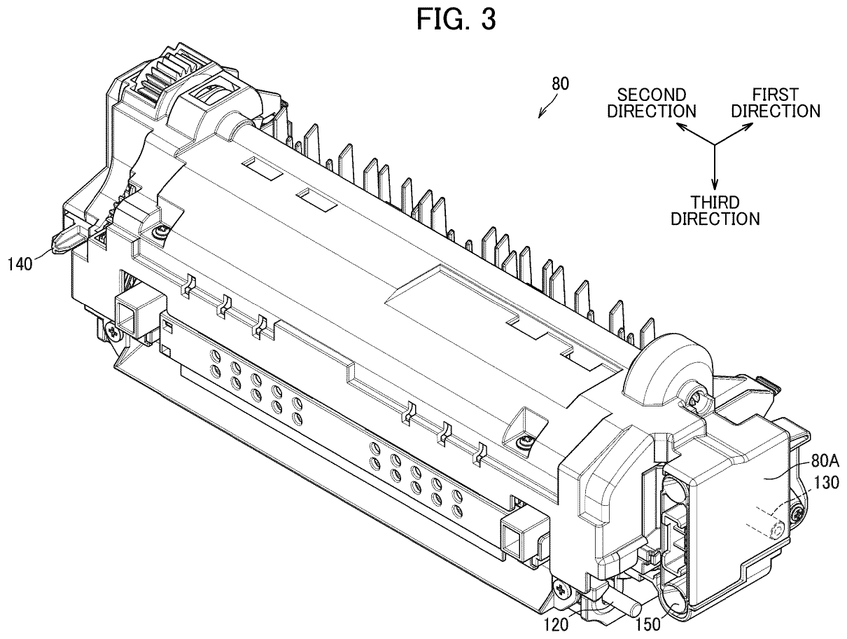

As illustrated in FIGS. 2 and 3, the fixing device 80 has a side surface 80A. The side surface 80A is configured to face the first side wall 10A in the process of the fixing device 80 being attached to the main housing 10. In the process of the fixing device 80 being attached to the main housing 10, the protrusions 400 are configured to make contact with the side surface 80A to restrict the posture of the fixing device 80. The protrusions 400 will be described later in detail.

The side surface 80 is a surface of a wall that covers a connector 150 of the fixing device 80 from the other side in the second direction (i.e., from the left side). The connector 150 is configured to be connected to a connector of the main housing 10 to receive power therefrom in a state where the fixing device 80 is attached to the main housing 10.

As illustrated in FIGS. 2 and 3, the fixing device 80 has two first bosses 120, two second bosses 130, and a protruding part 140. The first bosses 120 and second bosses 130 are arranged one each on each end portion of the fixing device 80 in the second direction. The first boss 120 is an example of ‘first boss’ of the disclosure. The second boss 130 is an example of ‘second boss’ of the disclosure.

The first bosses 120 are configured to make contact with the main housing 10 to provide positioning of the fixing device 80 relative to the main housing 10 in both the first direction and the third direction. The second bosses 130 are configured to make contact with the main housing 10 to restrict the fixing device 80 from pivoting about the axes of the first bosses 120.

Each first boss 120 is columnar in shape and has a cylindrical peripheral surface. Each second boss 130 is columnar in shape and has a cylindrical peripheral surface. The second bosses 130 are positioned on the one side in the third direction (i.e., downward) relative to the first bosses 120. The first bosses 120 and second bosses 130 extend in the second direction.

The protruding part 140 is positioned on a surface of the fixing device 80 on the other side in the first direction (i.e., on the front side). The protruding part 140 is arranged at an end of the fixing device 80 at the one side in the second direction and protrudes toward the other side in the first direction (i.e., toward the front). The protruding part 140 has a cross-shaped cross-section taken along a plane orthogonal to the first direction. The protruding part 140 is tapered toward the other side in the first direction such that a protruding end of the protruding part 140 at the other side in the first direction is thinner than a base end of the protruding part 140 at the one side in the first direction.

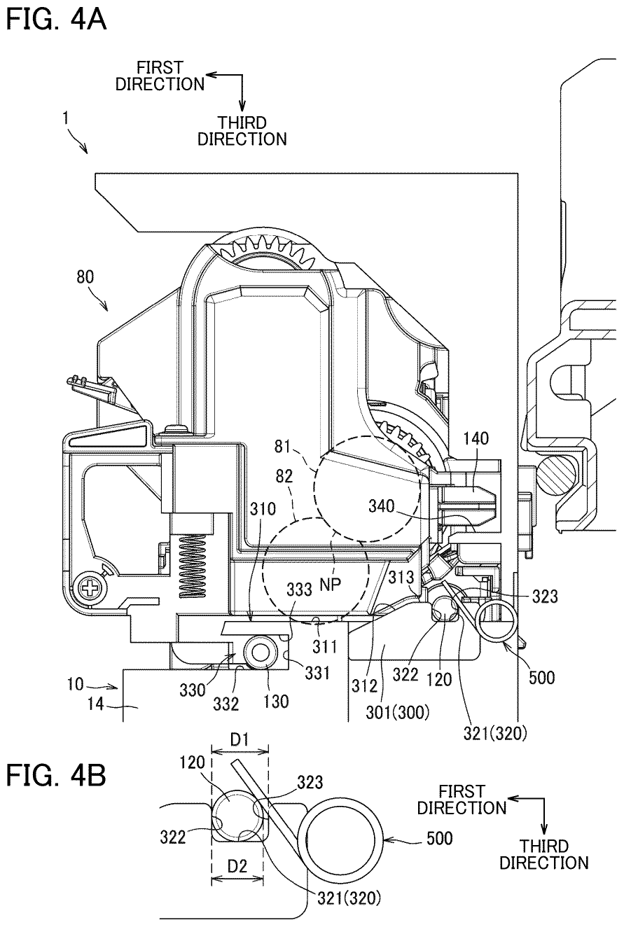

As illustrated in FIG. 4A, the main housing 10 has a guide surface 310, two first recesses 320, and two second recesses 330. The first recesses 320 and the second recesses 330 are arranged one each at each end portion of the main housing 10 in the second direction. Hereinafter, the guide surface 310, the first recess 320 and the second recess 330 only at the one side of the main housing 10 in the second direction will be described, and description for the first recess 320 and the second recess 330 at the other side of the main housing 10 in the second direction will be omitted to avoid duplicating description. The guide surface 310 is an example of ‘guide surface’ of the disclosure. The first recess 320 is an example of ‘first recess’ of the disclosure. The second recess 330 is an example of ‘second recess’ of the disclosure.

The first recess 320 is a recess recessed toward the one side in the third direction. The corresponding first boss 120 of the fixing device 80 is received in the first recess 320 in the state where the fixing device 80 is attached to the main housing 10. The first boss 120 is positioned further toward the other side in the first direction (on the front side) relative to a nip position defined between the heating roller 81 and the pressure roller 82. The main housing 10 further includes a metal plate 300. The metal plate 300 extends in the first direction and the third direction. The first recess 320 is formed on an end of the metal plate 300 at the other side in the third direction (i.e., at the upper end of the metal plate 300).

The first recess 320 has a first reference surface 321, a second reference surface 322, and a stopper surface 323.

The first reference surface 321 is a surface of the first recess 320 at the one side in the third direction. The first reference surface 321 defines the bottom of the first recess 320. The first reference surface 321 is orthogonal to the third direction.

The second reference surface 322 is a surface of the first recess 320 at the one side in the first direction. The second reference surface 322 extends from one end of the first reference surface 321 at the one side in the first direction toward the other side in the third direction. The second reference surface 322 crosses the first direction. In the present embodiment, the second reference surface 322 is orthogonal to the first direction.

The stopper surface 323 is a surface of the first recess 320 at the other side in the first direction. The stopper surface 323 extends from the other end of the first reference surface 321 at the other side in the first direction toward the other side in the third direction. The stopper surface 323 crosses the first direction. In the present embodiment, the stopper surface 323 is orthogonal to the first direction. The stopper surface 323 functions to restrict the fixing device 80 from moving further toward the other side in the first direction (toward the front) in a case where the first boss 120 of the fixing device 80 comes into contact with the stopper surface 323 during the attachment of the fixing device 80 to the main housing 10.

As illustrated in FIG. 4B, the first recess 320 is so sized that a distance D1 in the first direction between the second reference surface 322 and the stopper surface 323 is greater than a dimension D2 in the first direction of the first boss 120. Specifically, the distance D1 in the first direction between the second reference surface 322 and the stopper surface 323 is greater than a diameter D2 of the first boss 120.

As illustrated in FIG. 4A, the guide surface 310 is a surface for guiding the first boss 120 toward the first recess 320 in the process of the fixing device 80 being attached to the main housing 10. The guide surface 310 has a first guide surface 311, a second guide surface 312, and a third guide surface 313.

The first guide surface 311 extends in the first direction. The first guide surface 311 is formed in a first side frame 14 positioned on the one side of the main housing 10 in the second direction. The first guide surface 311 is at a different position from the third guide surface 313 in the third direction. Specifically, the first guide surface 311 is positioned further toward the one side in the first direction (downward) relative to the third guide surface 313.

The second guide surface 312 and the third guide surface 313 are formed in the metal plate 300. The first recess 320 is formed on the third guide surface 313. The second guide surface 312 is positioned between the first guide surface 311 and the third guide surface 313 in the first direction. The second guide surface 312 is sloped relative to the first direction. Specifically, the second guide surface 312 is sloped diagonally toward the other side in the third direction (upward) as extending toward the other side in the first direction.

The third guide surface 313 is positioned between the second guide surface 312 and the first recess 320 in the first direction. The third guide surface 313 extends from an end of the second guide surface 312 at the other side in the first direction toward the other side in the first direction. The end of the third guide surface 313 at the other side in the first direction (the front end of the third guide surface 313) is connected to an end of the second reference surface 322 of the first recess 320 at the other side in the third direction (the upper end of the second reference surface 322).

The second recess 330 is a recess recessed toward the other side in the first direction (toward the front). The second recess 330 is formed in the first side frame 14 of the main housing 10. In the state where the fixing device 80 is attached to the main housing 10, the corresponding second boss 130 of the fixing device 80 is received in the second recess 330. The second boss 130 is positioned further toward the one side in the first direction (on the rear side) relative to the nip position between the heating roller 81 and the pressure roller 82. The second recess 330 is open toward the one side in the first direction. The second recess 330 has a bottom surface 331, a first restricting surface 332, and a second restricting surface 333.

The bottom surface 331 is a surface of the second recess 330 at the other side in the first direction.

The first restricting surface 332 and the second restricting surface 333 function to restrict the fixing device 80 from pivoting about the axis of the first boss 120. The first restricting surface 332 extends from one end of the bottom surface 331 at the one side in the third direction toward the one side in the first direction. The second restricting surface 333 extends from the other end of the bottom surface 331 at the other side in the third direction toward the one side in the first direction. The second boss 130 is located between the first restricting surface 332 and the second restricting surface 333 when received in the second recess 330.

The image forming apparatus 1 further includes a spring 500. As an example, the spring 500 is a torsion coil spring (or a helical torsion spring). In the state where the fixing device 80 is attached to the main housing 10, the spring 500 urges the corresponding first boss 120 received in the first recess 320 toward the one side in the first direction and toward the one side in the third direction. In FIGS. 4A through 6B, the spring 500 is illustrated in a simplified manner. The spring 500 is an example of ‘spring’ of the disclosure.

While being urged by the spring 500, the first boss 120 is in contact with both the first reference surface 321 and the second reference surface 322 of the first recess 320. While being urged by the spring 500, the first boss 120 is apart from the stopper surface 323 of the first recess 320. That is, a gap is formed between the first boss 120 and the stopper surface 323 in a state where the first boss 120 is urged by the spring 500.

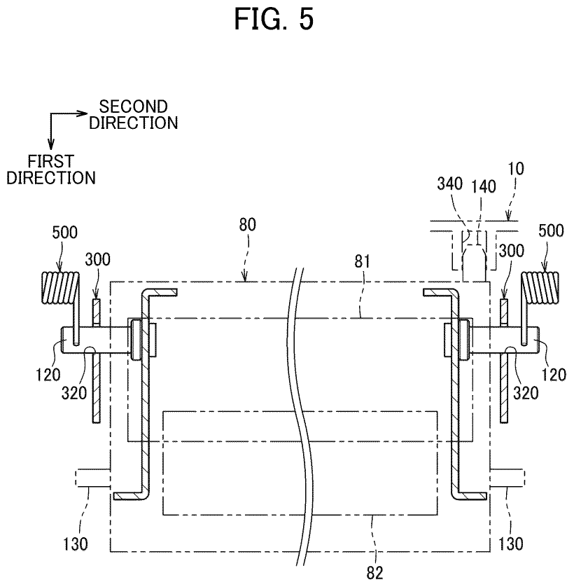

As illustrated in FIG. 5, the main housing 10 also has an elongated hole 340. The elongated hole 340 is a hole with a closed bottom and is elongated in the third direction. The elongated hole 340 is recessed toward the other side in the first direction. The elongated hole 340 is open toward the one side in the first direction. In the state where the fixing device 80 is attached to the main housing 10, the protruding part 140 of the fixing device 80 is received in the elongated hole 340. The fixing device 80 is fixed in position relative to the main housing 10 in the second direction by the protruding part 140 being received in the elongated hole 340.

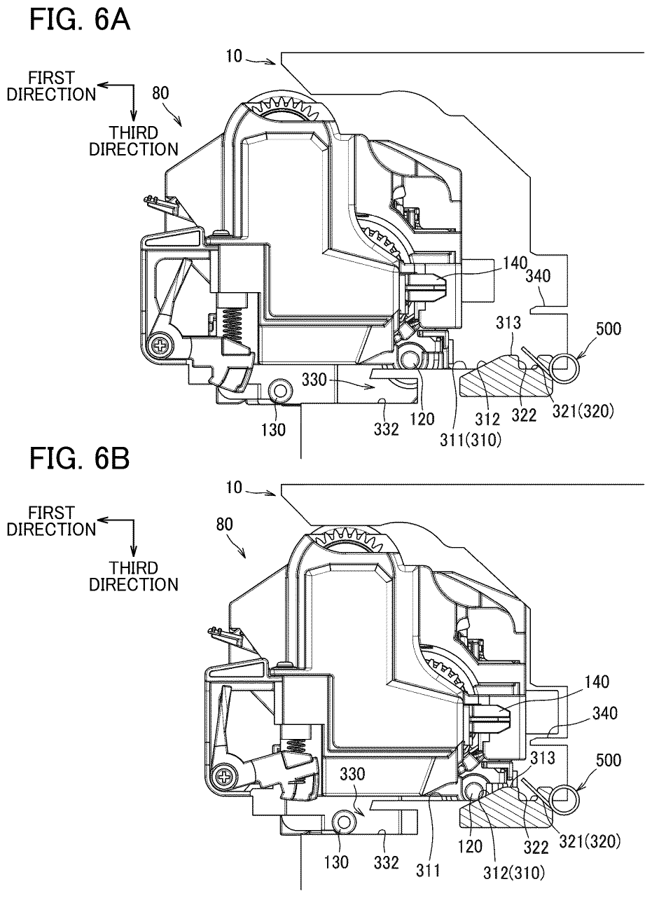

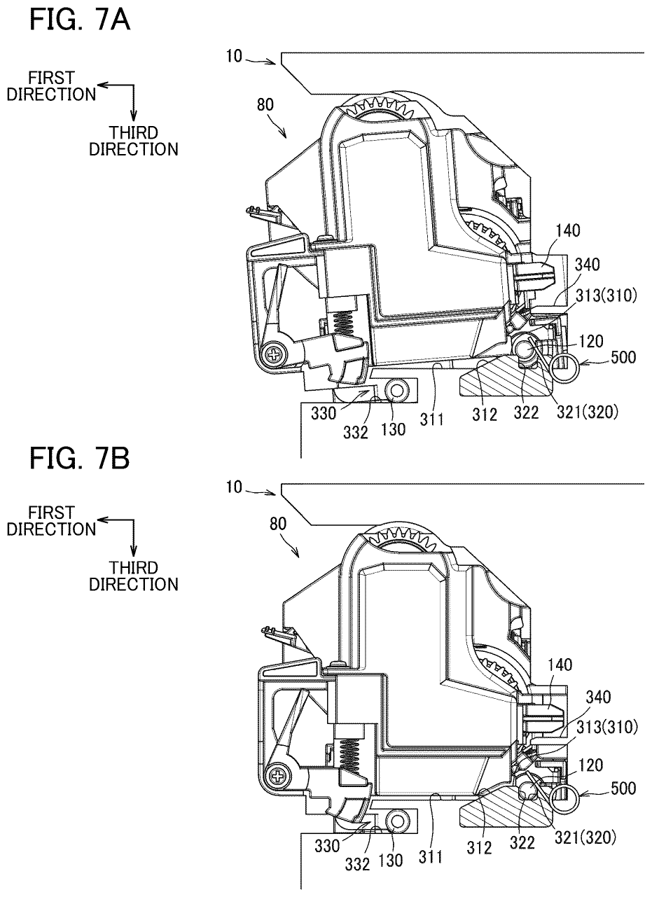

The elongated hole 340 has a dimension in the second direction that is substantially equal to the dimension in the second direction of the protruding part 140. The protruding part 140 is fitted into the elongated hole 340 in the first direction. The elongated hole 340 functions to restrict the protruding part 140 fitted in the elongated hole 340 from moving in the second direction, thereby restricting the fixing device 80 from moving in the second direction. The elongated hole 340 has a dimension in the third direction that is greater than the dimension in the third direction of the protruding part 140 (see FIGS. 6A to 7B, for example).

Next, how each element or part functions in the process of the fixing device 80 being attached to the main housing 10. In the following description, elements or parts of the fixing device 80 and the main housing 10 on the one side in the second direction will be described, whereas those on the other side in the second direction (having the similar structure as the one side in the second direction) will not be described for simplifying description.

As illustrated in FIG. 6A, in a process for moving the fixing device 80 toward the other side in the first direction for attachment thereof to the main housing 10, the first boss 120 comes into contact with the first guide surface 311 of the guide surface 310. The first boss 120 is thus guided by the first guide surface 311.

Thereafter, the second boss 130 comes into contact with the first restricting surface 332 of the second recess 330, as illustrated in FIG. 6B. The second boss 130 is thus guided by the first restricting surface 332.

After the first boss 120 contacts the second guide surface 312, the first boss 120 moves, along the second guide surface 312, diagonally toward the other side in the third direction and toward the other side in the first direction (i.e., diagonally upward and frontward). This movement of first boss 120 along the second guide surface 312 causes the fixing device 80 to pivot about an axis extending in the second direction, such that the fixing device 80 is inserted into the main housing 10 with the surface of the fixing device 80 on the other side in the first direction (i.e., the front surface of the fixing device 80) facing diagonally toward the other side in the third direction and toward the other side in the first direction (i.e., diagonally upward and frontward), as illustrated in FIG. 7A. After being guided by the second guide surface 312, the first boss 120 is guided by the third guide surface 313 toward the other side in the first direction. While the first boss 120 is being guided by the guide surface 310 in this way, the protruding part 140 enters the elongated hole 340.

After the first boss 120 is off the third guide surface 313, the first boss 120 is moved into the first recess 320 by the urging force of the spring 500, as illustrated in FIG. 7B. At this time, the second boss 130 is located inside the second recess 330.

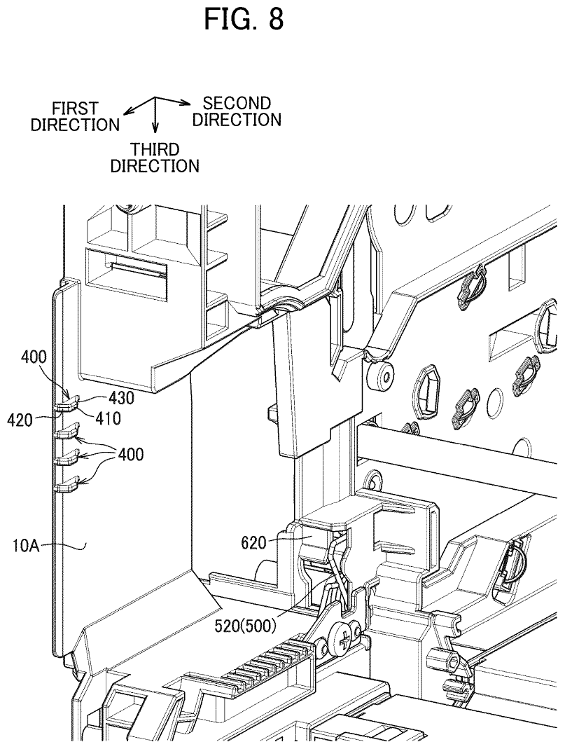

As illustrated in FIG. 8, the protrusions 400 are each in a form of a rib extending in the first direction. Each protrusion 400 has a guide surface 410, a first sloped surface 420, and a second sloped surface 430.

The guide surface 410 extends in the first direction.

The first sloped surface 420 extends from one end of the guide surface 410 at the one side in the first direction toward the one side in the first direction. The first sloped surface 420 is sloped relative to the guide surface 410 such that the first sloped surface 420 extends farther away from the second side wall 10B in the second direction as extending toward the one side in the first direction.

The second sloped surface 430 extends from the other end of the guide surface 410 at the other side in the first direction toward the other side in the first direction. The second sloped surface 430 is sloped relative to the guide surface 410 such that the second sloped surface 430 extends farther away from the second side wall 10B in the second direction as extending toward the other side in the first direction.

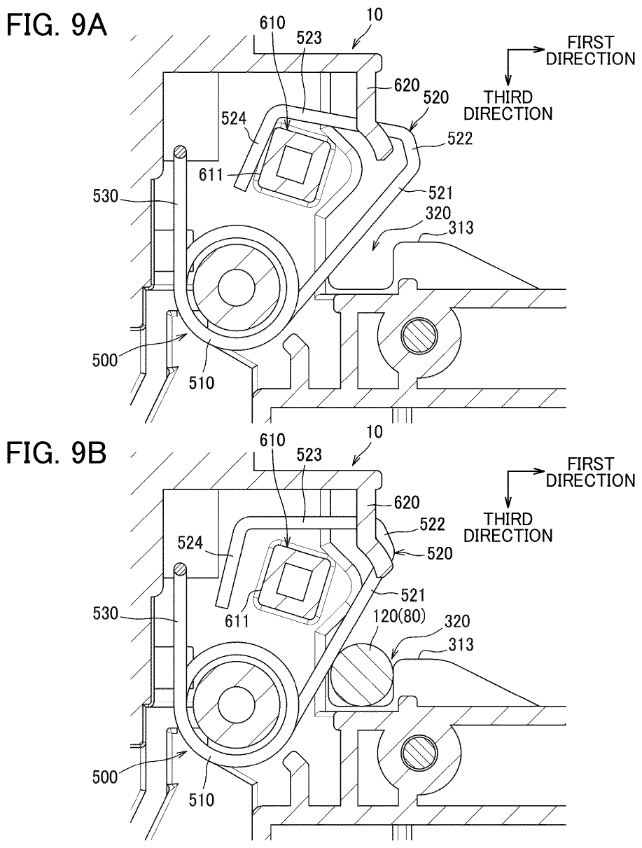

As illustrated in FIGS. 9A and 9B, the spring 500 has a coil 510, a first arm 520, and a second arm 530.

The coil 510 is disposed adjacent to the first recess 320 in the first direction. The coil 510 is positioned on the other side of the first recess 320 in the first direction.

The coil 510 extends from one end of the coil 510 at the one side in the first direction. The first arm 520 is configured to contact the first boss 120. The first arm 520 has a first portion 521, a second portion 522, a third portion 523, and a fourth portion 524.

The first portion 521 extends, from one end of the coil 510 at the one side in the first direction, diagonally toward the one side in the first direction and toward the other side in the third direction. As illustrated in FIG. 9A, the first portion 521 overlaps the first recess 320 when viewed in the second direction in a state where the fixing device 80 is detached from the main housing 10.

Hereinafter, the state where the fixing device 80 is not attached to the main housing 10 will be referred to as “detached state” and the state where the fixing device 80 is attached to the main housing 10 will be referred to simply as “attached state.” The detached state denotes a state before the fixing device 80 is inserted into the main housing 10. The attached state denotes a state where the first boss 120 is received in the first recess 320. In the attached state, the fixing device 80 can thermally fix a toner image to a sheet S.

In the detached state, the first portion 521 is sloped relative to the third guide surface 313 of the guide surface 310. In the detached state, the first portion 521 has a part apart from the third guide surface 313 toward the other side in the third direction.

The second portion 522 extends from the end of the first portion 521 opposite the coil 510. The second portion 522 is bent toward the second arm 530 from the first portion 521.

The third portion 523 extends from the end of the second portion 522 opposite the first portion 521. The third portion 523 is bent toward the coil 510 from the second portion 522.

The fourth portion 524 constitutes a tip end portion of the first arm 520. The fourth portion 524 extends from the end of the third portion 523 opposite the second portion 522. The fourth portion 524 is bent toward the first portion 521 from the third portion 523.

The second arm 530 extends from the other end of the coil 510 at the other side in the first direction. The second arm 530 is supported by the main housing 10.

The main housing 10 includes a first restricting part 610 and a second restricting part 620.

As illustrated in FIG. 9A, the first restricting part 610 functions to restrict the position of the first arm 520 in a circumferential direction of the coil 510 in the detached state.

The first restricting part 610 restricts the first arm 520 from moving in a direction for pressing the first boss 120 against the bottom (first reference surface 321) of the first recess 320. In other words, the first restricting part 610 restricts the first arm 520 from moving toward the one side in the first direction and toward the one side in the third direction.

The first restricting part 610 is a boss having a rectangular shape in cross-section. The first restricting part 610 is positioned further toward the other side in the third direction relative to the coil 510. The first restricting part 610 is positioned further toward the other side in the first direction relative to the second portion 522 of the first arm 520.

The first restricting part 610 has a restricting surface 611. In the detached state, the restricting surface 611 is in contact with the fourth portion 524 constituting the tip ed portion of the first arm 520. In the attached state, the fourth portion 524 is apart from the restricting surface 611. The restricting surface 611 is substantially orthogonal to the circumferential direction of the coil 510. The restricting surface 611 faces toward the other side in the first direction (i.e., rearward).

As illustrated in FIGS. 8 through 9B, the second restricting part 620 functions to restrict the first arm 520 from moving away from the fixing device 80 in the second direction. The second restricting part 620 is positioned between the first arm 520 and the first side wall 10A in the second direction.

The second restricting part 620 is arranged adjacent to the first arm 520 in the second direction. In the detached state, the second restricting part 620 overlaps the third portion 523 of the first arm 520 when viewed in the second direction.

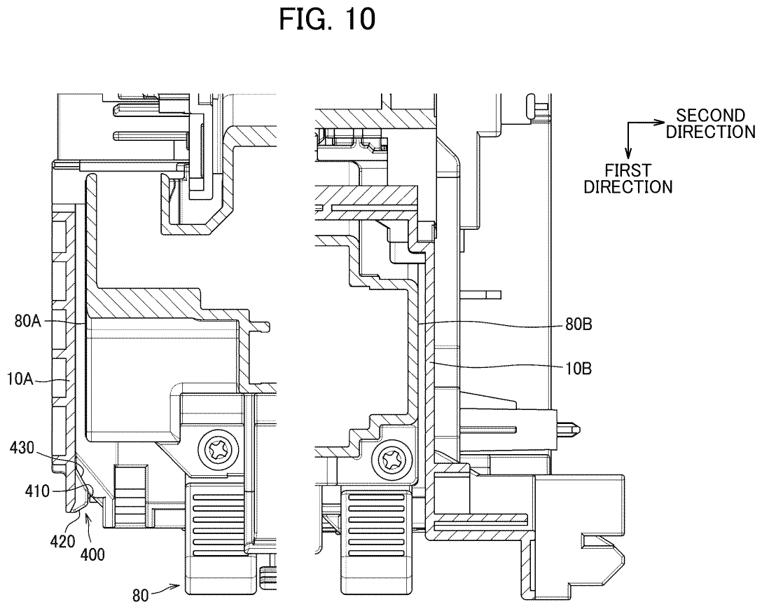

As illustrated in FIG. 10, in the attached state, the side surface 80A of the fixing device 80 is apart from the main housing 10. In the attached state, a side surface 80B of the fixing device 80 opposite the side surface 80A is apart from the second side wall 10B.

In the attached state, the side surface 80A of the fixing device 80 is positioned further toward the other side in the first direction (i.e., frontward) relative to the protrusions 400. With this arrangement, as illustrated in FIG. 10B, in the attached state, the protrusions 400 do not overlap the side surface 80A of the fixing device 80 when viewed in the second direction.

As illustrated in FIG. 10, in the attached state, the protrusions 400 protrude slightly further in the second direction toward the second side wall 10B (toward the one side in the second direction) relative to the side surface 80A, such that the guide surface 410 is positioned slightly closer to the second side wall 10B than the side surface 80A is to the second side wall 10B in the second direction. That is, after being guided by the protrusions 400 at the side surface 80A, the fixing device 80 moves slightly closer toward the first side wall 10A to be attached to the main housing 10. This movement of the fixing device 80 relative to the main housing 10 occurs in a process in which the protruding part 140 of the fixing device 80 is received in the elongated hole 340.

The dimension in the second direction from each guide surface 410 to the inner surface of the second side wall 10B is substantially the same as the dimension in the second direction from the side surface 80A to the side surface 80B of the fixing device 80. This structure ensures that the side surface 80A comes into contact with the guide surfaces 410 of the protrusions 400 in an initial stage of the insertion of the fixing device 80 into the main housing 10.

Next, the relationship between the side surface 80A and the protrusions 400 during the attachment of the fixing device 80 to the main housing 10 will be described.

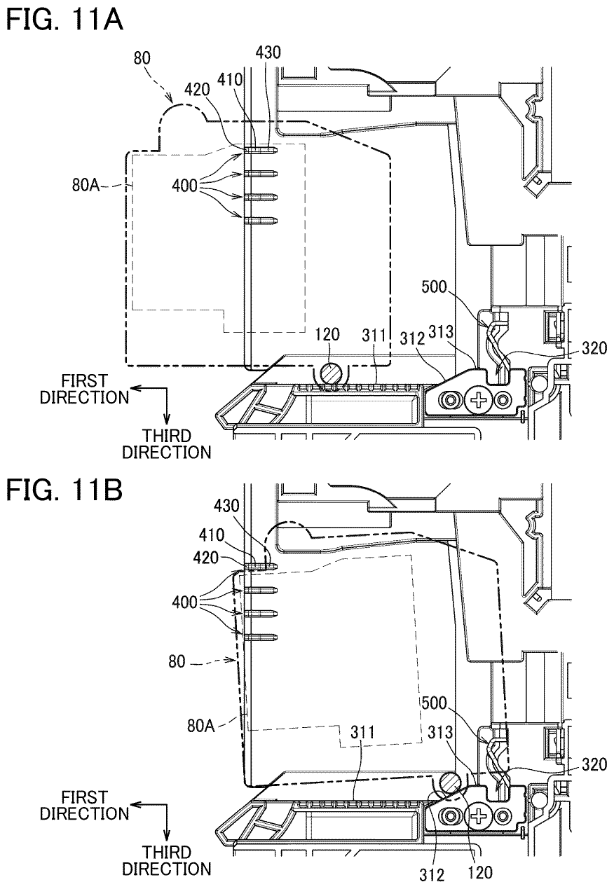

As illustrated in FIG. 11A, the side surface 80A overlaps all of the four protrusions 400 when viewed in the second direction, while the first boss 120 is being guided by the first guide surface 311. Specifically, when viewed in the second direction, the side surface 80A overlaps all of the four guide surfaces 410.

Hence, in the initial stage of the insertion of the fixing device 80 into the main housing 10, the side surface 80A comes into contact with the four guide surfaces 410. This configuration can restrict the fixing device 80 from being inserted into the main housing 10 in such a posture that one longitudinal end of the fixing device 80 is located farther forward in the attachment direction than the other longitudinal end. This configuration can thus restrict the fixing device 80 from skewing about an axis extending in the third direction.

As illustrated in FIG. 11B, while the first boss 120 is guided by the second guide surface 312, the fixing device 80 pivots about the axis extending in the second direction to assume such a posture that the surface of the fixing device 80 on the downstream side in the attachment direction (i.e., the front surface) faces diagonally toward the other side in the third direction (diagonally upward). The side surface 80A thus overlaps lower three of the four protrusions 400 when viewed in the second direction. Specifically, when viewed in the second direction, the side surface 80A overlaps the lower three guide surfaces 410 except the upper most guide surface 410.

This structure enables the three guide surfaces 410 to regulate the posture of the fixing device 80 even when the fixing device 80 skews such that its surface on the downstream side in the attachment direction (front surface) faces diagonally toward the other side in the third direction (upward).

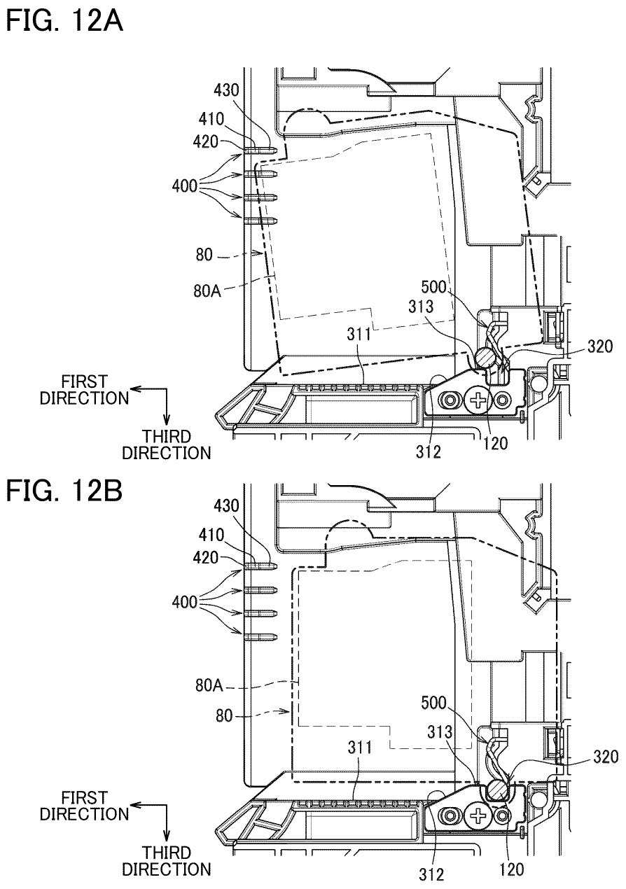

As illustrated in FIG. 12A, the fixing device 80 is kept tiled with its surface on the downstream side in the attachment direction faces diagonally toward the other side in the third direction until just before the first boss 120 on the third guide surface 313 is received in the first recess 320. At the moment immediately before the first boss 120 is received in the first recess 320, the side surface 80A overlaps the lower three of the four protrusions 400 when viewed in the second direction.

Specifically, when viewed in the second direction, the side surface 80A overlaps the lower three second sloped surfaces 430 when viewed in the second direction. With this structure, in a process of the first boss 120 on the third guide surface 313 falling onto the first recess 320 and being received in the first recess 320, the fixing device 80 is allowed to move gradually by a larger distance toward the other side in the second direction.

In the process of the first boss 120 on the third guide surface 313 moving toward the first recess 320 and being received in the first recess 320, the protruding part 140 of the fixing device 80 (see FIG. 5) enters the elongated hole 340 of the main housing 10. In the process of the protruding part 140 being received in the elongated hole 340, the fixing device 80 moves slightly toward the other side in the second direction and is fixed in position relative to the main housing 10 in the second direction.

In the state where the protruding part 140 is received in the elongated hole 340 and the first boss 120 is received in the first recess 320, the side surface 80A overlaps none of the four protrusions 400 when viewed in the second direction, as illustrated in FIG. 12B.

The above-described embodiment can achieve the following technical advantages.

The side surface 80A of the fixing device 80 are so designed to overlap the protrusions 400 when viewed in the second direction during the process of the fixing device 80 being attached to the main housing 10. With this configuration, the protrusions 400 can regulate the posture of the fixing device 80 to be inserted into the main housing 10, thereby enabling the protrusions 400 to guide he fixing device 80 into the correct location inside the main housing 10.

Further, the side surface 80A does not overlap any of the protrusions 400 when viewed in the second direction in the attached state. With this arrangement, the protrusions 400 do not hinder the positioning of the fixing device 80 relative to the main housing 10.

The protrusions 400 are provided as ribs extending in the first direction. This structure can reduce sliding resistance to be generated between the side surface 80A of the fixing device 80 and the protrusions 400 during the attachment of the fixing device 80 to the main housing 10.

Further, the protrusions 400 are aligned in the third direction. This structure can disperse contact pressure to be generated between the side surface 80A of the fixing device 80 and the protrusions 400 during the attachment of the fixing device 80 to the main housing 10.

Still further, each protrusion 400 has the guide surface 410 and the first sloped surface 420. With this arrangement, the first sloped surface 420 can guide the fixing device 80 reliably onto the guide surface 410 during the attachment of the fixing device 80 to the main housing 10. Since each protrusion 400 also has the second sloped surface 430 in addition to the guide surface 410, the second sloped surface 430 can reliably guide the fixing device 80 onto the guide surface 410 during the detachment of the fixing device 80 from the main housing 10.

The protruding part 140 received in the elongated hole 340 of the main housing 10 is restricted from moving in the second direction relative to the main housing 10, thereby realizing the positioning of the fixing device 80 in the second direction relative to the main housing 10.

The spring 500 is configured to urge the first boss 120 to be pressed against the bottom (first reference surface 321) of the corresponding first recess 320, thereby realizing the positioning of the fixing device 80 in the third direction relative to the main housing 10.

The protrusions 400 overlap the side surface 80A when viewed in the second direction while the first boss 120 is on the second guide surface 312. The protrusions 400 can thus guide the fixing device 80 even while the fixing device 80 is tiled with its surface on the downstream side in the attachment direction (front surface) facing diagonally toward the other side in the third direction (upward).

Since the spring 500 is provided as a coil spring, the pressing force and stroke of the spring 500 can be set reliably.

Since the main housing 10 includes the first restricting part 610, the first restricting part 610 can regulate the position of the first arm 520 of the spring 500 in the circumferential direction of the coil 510 in the detached state.

Since the main housing 10 also includes the second restricting part 620, the second restricting part 620 can restrict the first arm 520 of the spring 500 from moving in the second direction. For example, as described above, the fixing device 80 is designed to move in the second direction immediately before the attachment of the fixing device 80 to the main housing 10 is completed. At this time, conceivably, the first boss 120 of the fixing device 80 may urge the first arm 520 to move in the second direction. However, the second restricting part 620 can restrict the first arm 520 from moving in the second direction even when the first arm 520 is urged to move in the second direction by the pressure from the first boss 120.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, the first side wall 10A may have at least one protrusion 400, rather than four of the protrusions 400.

The spring 500 of the embodiment is hook shaped with the first arm 520 bent toward the other side in the first direction. Alternatively, the first arm 520 may extend linearly from the coil 510 to have a linear shape. In this case, the first restricting part 610 may be arranged on the one side of the first arm 520 in the first direction and contact the first arm 520.

The shapes of the first and second restricting parts 610 and 620 need not be those of the described embodiment, and may be modified as appropriate.

The spring 500 of the embodiment is configured as a torsion coil spring. However, the spring of the disclosure may be a leaf spring or a compressed coil spring, provided that the spring can press the first boss 120 of the fixing device 80.

In the embodiment, the third direction is orthogonal to the first direction. However, the third direction need not be orthogonal to the first direction. That is, although the first recess 320 is recessed toward the one side in the third direction (toward the bottom of the image forming apparatus 1) in the embodiment, the first recess of the disclosure may be recessed diagonally toward the one side in the third direction and toward the other side in the first direction (diagonally downward and frontward). In the described embodiment, the first direction corresponds to the direction in which the fixing device 80 is to be attached to and detached from the main housing 10 and also corresponds to the front-rear direction of the image forming apparatus 1. However, the first direction of the disclosure may be sloped relative to a horizontal direction.

While the heating roller 81 is employed as an example of ‘heating rotator’ of the disclosure in the above-described embodiment, the ‘heating rotator’ of the disclosure may be exemplified as a heating belt or a heating film, for example. Further, the ‘pressure rotator’ of the disclosure may be exemplified as an endless belt nipped between an elastic pad and the ‘heating rotator’ of the disclosure.

In the embodiment described above, the image forming apparatus 1 as an example of ‘image forming apparatus’ of the disclosure is a printer capable of forming color images. Alternatively, the image forming apparatus of the disclosure may be embodied as a printer configured to form images only in black and white. Still alternatively, the image forming apparatus of the disclosure may be a copying machine, or a multifunction device.

Each and every element described in the above embodiment and variations thereof may be combined as appropriate.

What is claimed is:

1. An image forming apparatus comprising:
a main housing; and
a fixing device including a heating rotator and a pressure rotator, the fixing device being configured to be attached to the main housing from one side toward an other side in a first direction,
wherein the main housing includes a first side wall and a second side wall opposing the first side wall in a second direction crossing the first direction, the first side wall including a protrusion protruding toward the second side wall,
wherein the fixing device has a side surface configured to face the first side wall, and
wherein
during attachment of the fixing device to the main housing,
the protrusion restricts a posture of the fixing device by contacting the side surface of the fixing device, and the protrusion overlaps the side surface when viewed in the second direction, and
in a state where the fixing device is attached to the main housing,
the protrusion does not overlap the side surface when viewed in the second direction.

2. The image forming apparatus according to claim 1,
wherein the protrusion is a rib extending in the first direction.

3. The image forming apparatus according to claim 1,
wherein the first side wall further includes a second protrusion protruding toward the second side wall, the second protrusion contacting the side surface of the fixing device and restricting the posture of the fixing device during the attachment of the fixing device to the main housing, the protrusion and the second protrusion being arranged in a third direction crossing both the first direction and the second direction.

4. The image forming apparatus according to claim 1,
wherein the protrusion has:
a guide surface extending in the first direction, the guide surface having one end on the one side and an other end on the other side in the first direction;
a first sloped surface extending from the one end of the guide surface in the first direction, the first sloped surface being sloped relative to the guide surface to extend away from the second side wall toward the one side in the first direction; and
a second sloped surface extending from the other end of the guide surface in the first direction, the second sloped surface being sloped relative to the guide surface to extend away from the second side wall toward the other side in the first direction.

5. The image forming apparatus according to claim 1,
wherein the fixing device includes a protruding part protruding toward the other side in the first direction,
wherein the main housing has a hole, and
wherein, in the state where the fixing device is attached to the main housing,
the protruding part of the fixing device is received in the hole to restrict the fixing device from moving in the second direction.

6. The image forming apparatus according to claim 1,
wherein the fixing device includes a first boss extending in the second direction, and
wherein the main housing includes:
a first recess recessed in a third direction crossing both the first direction and the second direction, the first recess being configured to receive the first boss; and
a spring configured to urge the first boss against a bottom of the first recess.

7. The image forming apparatus according to claim 6,
wherein the main housing has a guide surface configured to guide the first boss toward the first recess during the attachment of the fixing device to the main housing, the guide surface having:
a first guide surface extending in the first direction;
a second guide surface being sloped relative to the first direction; and
a third guide surface having the first recess, the third guide surface and the first guide surface being at different positions in the third direction, the second guide surface being positioned between the first guide surface and the third guide surface in the first direction, and
wherein the protrusion overlaps the side surface of the fixing device when viewed in the second direction while the first boss is guided by the second guide surface.

8. The image forming apparatus according to claim 6,
wherein the spring is a torsion coil spring.

9. The image forming apparatus according to claim 8,
wherein the spring includes:
a coil having one end and an other end;
a first arm extending from the one end of the coil, the first arm being configured to contact the first boss of the fixing device; and
a second arm extending from the other end of the coil, the second arm being supported by the main housing,
wherein the main housing further includes a first restricting part configured to contact the first arm, and
wherein
in a state where the fixing device is detached from the main housing,
the first restricting part contacts the first arm to restrict the first arm from moving in a direction for pressing the first boss against the bottom of the first recess.

10. The image forming apparatus according to claim 9,
wherein the first restricting part is a boss having a rectangular shape in cross-section.

11. The image forming apparatus according to claim 9,
wherein the main housing further includes a second restricting part, the second restricting part restricting the first arm from moving toward the first side wall in the second direction.

12. The image forming apparatus according to claim 11,
wherein the second restricting part is a wall positioned between the first arm and the first side wall in the second direction.

13. The image forming apparatus according to claim 6,
wherein the fixing device further includes a second boss extending in the second direction, the first boss and the second boss being on opposite sides of a nip position defined between the heating rotator and the pressure rotator in the first direction, and
wherein the main housing further includes a second recess recessed toward the other side in the first direction, the second boss being received in the second recess during the attachment of the fixing device to the main housing.
